(19) United States
(12) Patent Application Publication
(10) Pub. No.: US 2025/0089605 A1
(43) Pub. Date: Mar. 20, 2025

(54) TRACTOR WITH INJECTOR FOR DEEP APPLICATION AND MIXING OF AMENDMENT WITH SOIL

(71) Applicants: Jeffrey L. Lehar, Paso Robles, CA (US); Monterey Pacific Inc., Soledad, CA (US)

(72) Inventor: Jeffrey L. Lehar, Paso Robles, CA (US)

(21) Appl. No.: 18/369,709

(22) Filed: Sep. 18, 2023

(51) Int. Cl. A01C 21/00; A01B 39/16; A01C 5/06; A01C 15/12

(52) U.S. Cl. CPC A01C 21/002; A01B 39/16; A01C 5/062; A01C 15/12

(57) ABSTRACT

Embodiments of the present invention relate to soil conditioning/amending equipment for use with a tractor or similar hauling equipment to improve soil conditions of a vineyard, orchard, field, or the like. Embodiments of the soil conditioning equipment include a leading bow-shaped structure that cuts through the soil when dragged from the surface by the tractor, etc. The bow shaped structure (“injector”) is part of an open chute that moves thorough the soil to break up the soil and create an opening for soil amendment to fall through. Compost and/or other soil amendments are poured on a conveyor and into the void landing roughly 1-3 feet below the soil line. The soil and amendments are mixed together in the wake of the injector by waterfall-like currents both above and below the soil line as the void in the soil collapses as the tractor moves forward.

### FIELD

Embodiments of the present invention generally relate to the field of soil conditioning. More specifically, embodiments of the present invention relate to methods and apparatus for deep application of amendment to soil.

### BACKGROUND

Modern agriculture practices aimed at improving soil conditions in vineyards and orchards at a large scale typically involve using specialized equipment such as plows, disk harrows, rototillers, rippers, and bedders connected to tractors and dragged across a soil bed to break up compacted soil and replenish soil nutrients. However, these approaches to soil conditioning and amendment typically reach less than a foot below the soil line, and are unable to mix soil amendments into the soil at significant depths. Unfortunately, compost and fertilizers can become toxic to the roots of plants when not sufficiently mixed with the existing soil.

Propper amendment of vineyard soil (amelioration) is an essential practice in viticulture to create optimal growing conditions for grapevines. Proper soil management can impact grape quality and yield. Compost and other soil amendments (e.g., organic matter, mulch, fertilizer, etc.) are often applied to vineyard soil at the soil line, or mixed in a few inches below the soil line. A more effective technique involves using a soil ripper as an underground tiller that helps alleviate soil compaction that occurs over time. For example, before new vines are planted, cover crops are typically sowed to replenish the soil nutrients, and the soil is then ripped in rows with amendment merely poured into ripped rows. Soil ripping helps improve soil structure, soil drainability and grapevine root system depth. However, while rippers can be used to somewhat improve the structure of the soil, they are unable to mix amendments like compost deep into the soil. Therefore, when conditioning soil using a ripper in a vineyard, the vine at the beginning of a row and the vine at the end of the row may experience different soil conditions at deeper levels, which can negatively affect yields and plant health. A more effective approach to soil conditioning that can mix compost and other soil amendments much deeper into the soil is desired. Deep amendment placement is advantageous because, under proper conditions with proper mixing, it will cause deep root growth and improve harvest yields.

### SUMMARY

Embodiments of the present invention relate to soil conditioning/amending equipment for use with a tractor or similar hauling equipment to improve soil conditions of a vineyard, orchard, field, or the like. Embodiments of the novel soil conditioning equipment include a leading bow-shaped structure that cuts through the soil when dragged from the surface by the tractor, etc. The bow shaped structure (“injector”) is part of an open chute that moves thorough the soil to break up the soil and create an opening for soil amendment to fall through. As the bow (shank and blades) cuts through the soil, a void in the soil is formed and supported by the blades and walls of the structure. Compost and/or other soil amendments are poured on the ramp and into the void landing roughly 1-3 feet below the soil line. The compost can be transported on a large vehicle having a conveyor or similar device that can transport soil, compost, fertilizer and the like over short distances. The soil and amendments are mixed together in the wake of the injector by waterfall-like currents both above and below the soil line as the void in the soil collapses as the tractor and amendment vehicle move forward together. In this way, the treated soil bed is significantly conditioned deep below the surface, and the mixed and amended soil bed provides nutrients that can be accessed by deep and mature root systems for healthy growth and increased bounty.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts exemplary equipment for performing deep soil amendment according to embodiments of the present invention.

FIG. 2 depicts exemplary equipment for performing deep soil amendment connected to a frame pulled by a tractor according to embodiments of the present invention.

FIG. 3 depicts exemplary equipment for performing deep soil amendment connected to a frame and a conveyor for moving compost and other soil amendments into a void in the soil created by an injector according to embodiments of the present invention.

FIG. 4 depicts exemplary equipment for performing deep soil amendment that can be connected to a tractor and fed using a conveyor that receives compost and other amendments from another conveyor connected to a second piece of equipment moving in parallel to the tractor according to embodiments of the present invention.

FIG. 5 depicts exemplary equipment for performing deep soil amendment from a side view above and below the soil line according to embodiments of the present invention.

FIG. 6 depicts exemplary equipment for performing deep soil amendment using an adjustable conveyor from a side view above and below the soil line according to embodiments of the present invention.

FIG. 7 is a flow chart depicting exemplary steps of a process for performing deep soil amendment to condition soil using compost or other soil amendments according to embodiments of the present invention.

FIG. 8 is a flow chart depicting exemplary steps of a process for conditioning soil including deep soil amendment that is mixed with the soil by an injector according to embodiments of the present invention.

FIG. 9 is a block diagram of exemplary ameliorated soil according to embodiments of the present invention.

FIG. 10 is a diagram of exemplary equipment for performing deep soil amendment using two injectors traveling parallel to rows of a vineyard according to embodiments of the present invention.

FIG. 11 is a flow chart depicting exemplary steps of a process for performing deep soil amendment using two injectors traveling parallel to rows of a vineyard according to embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

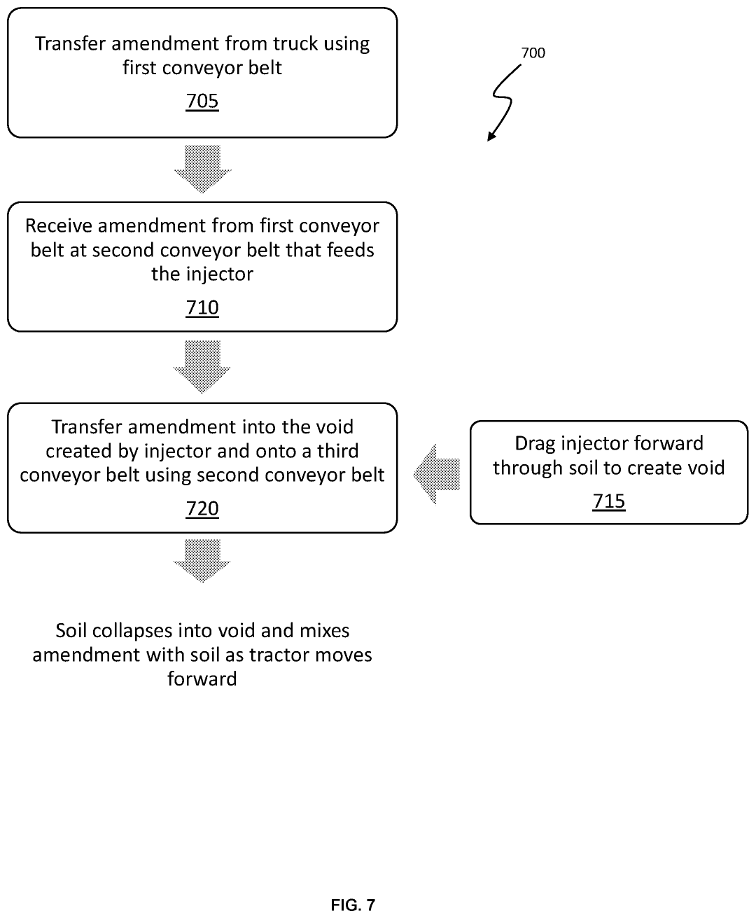

Portions of the detailed description that follows are presented and discussed in terms of a method. Although steps and sequencing thereof are disclosed in a figure herein (e.g., FIGS. 7, 8, and 11) describing the operations of this method, such steps and sequencing are exemplary. Embodiments are well suited to performing various other steps or variations of the steps recited in the flowchart of the figure herein, and in a sequence other than that depicted and described herein.

### Preparation and Treatment of Soil Including Deep Application and Mixing of Amendment

Embodiments of the present invention relate to soil conditioning/amending equipment for use with a tractor or similar hauling equipment to improve soil conditions of a vineyard, orchard, field, or the like. Embodiments of the soil conditioning equipment include a leading bow-shaped structure that cuts through the soil when dragged from the surface by the tractor, etc. The bow shaped structure (“injector”) is part of an open chute that moves thorough the soil to break up the soil and create an opening for soil amendment to fall through. As the bow (shank and blades) cuts through the soil, a void in the soil is formed and supported by the blades and walls of the structure. Compost and/or other soil amendments are poured on a conveyor and into the void landing roughly 1-3 feet below the soil line, with some of the compost falling onto another conveyor that moves the amendment into the wake created in the soil behind the injector. The compost can be on a large vehicle having a conveyor or similar device that can transport soil, compost, fertilizer and the like over short distances. The soil and amendments are mixed together in the wake of the injector by waterfall-like currents both above and below the soil line as the void in the soil collapses as the tractor (and the amendment vehicle in some cases) move forward. In this way, the treated soil bed is significantly conditioned deep below the surface, and the mixed and amended soil bed provides nutrients that can be accessed by deep and mature root systems for healthy growth and increased bounty.

Some embodiments described herein use a conveyor to retrieve compost, biochar, or other soil amendments from a truck or tractor. According to some embodiments, multiple conveyors are used in coordination to transport compost into the open chute of the injector. Some embodiments use two injectors running parallel to rows of a vineyard with each injector being fed by a conveyor. According to one embodiment, the soil bed is prepared by a ripper before amending the soil with the injector, and the soil bed is then bedded to cap the soil which can prevent soil collapse after the soil bed is amended and mixed using the injector.

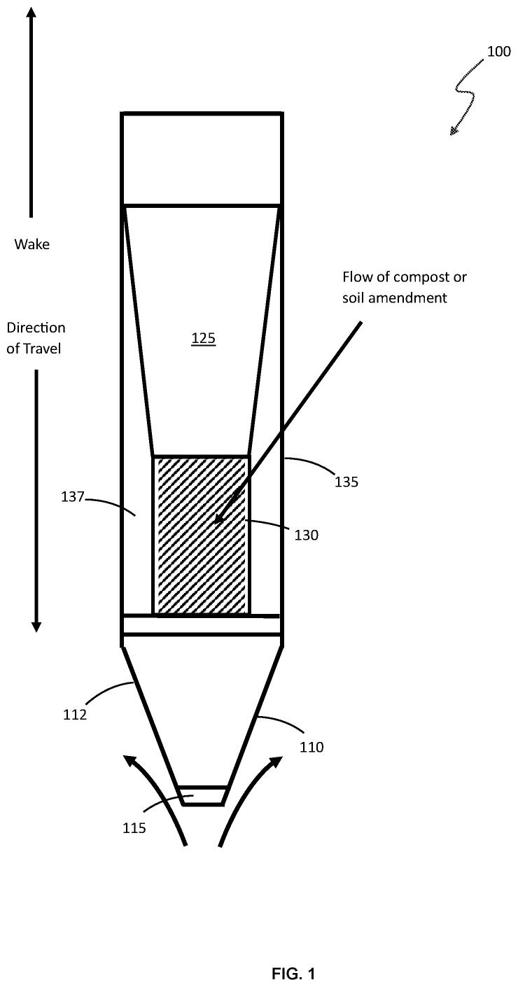

FIG. 1 depicts a top view of an exemplary injector 100 for performing deep soil amendment according to embodiments of the present invention. Injector 100 typically includes an edge formed by a steel shank 115 flanked by steel blades 110, 112 in a bow shape to form a chute 125 that extends down over a foot below the surface of the soil. The components can be welded together or otherwise formed into a shape that cuts though soil to create a void in the soil that soil amendment can be dropped into and mixed advantageously. According to the embodiment of FIG. 1, the tip of the bow is a 3″ wide shank 115 connected to blades 110, 112 for cutting through compacted soil. Blades 110, 112 can be made from steel and covered by carbide wear plates to improve durability. The chute 125 formed by lateral plates 135, 137 can be roughly 4 feet tall and 1 foot wide and can extend feet below the surface of the soil to “inject” soil amendment into the hole or void 130 formed in the soil by injector 100. In the example of FIG. 1, the compost/soil amendment flows through a 3×1 foot opening at the bottom of chute 125 and is then mixed into the soil by the wake of the injector moving through the soil as the void collapses. For example, embodiments of the present invention can fully mix soil and compost at depths of roughly 3 feet to ameliorate soil by injecting a consistent rate of compost into the soil. The example of FIG. 1 is intended to be attached to a frame or other device typically placed above the injector to connect the injector to a tractor or truck that can pull the injector at a consistent speed for advantageously delivering compost and soil amendment at a consistent rate, which improves yields and plant health. Using such equipment, up to 77 tons of amendment can be deeply deposited and mixed with soil per linear acre, or 31 lbs. per foot. The amendment can include organic materials, such as compost or biochar, and synthetic materials, such as synthetic fertilizers and the like.

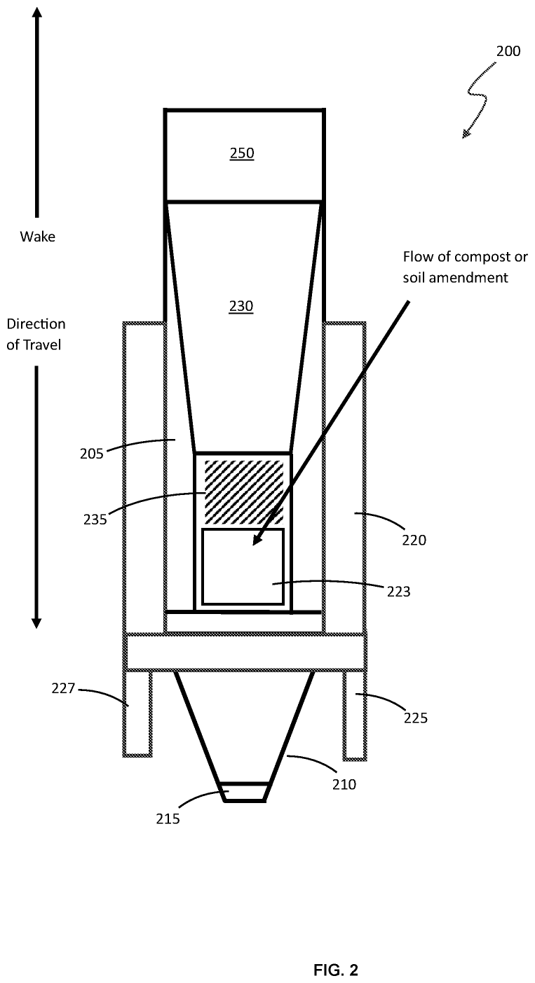

Similar to FIG. 1, FIG. 2 depicts exemplary an exemplary apparatus 200 including an injector 250 for performing deep soil amendment. In the example of FIG. 2, injector 250 is connected to a removeable frame 220 pulled by a tractor according to embodiments of the present invention. The frame 220 can be a heavy steel frame that sits on top of shank 215, blades 210, and body 205 of injection 200 to connect injector 200 to a tractor that pulls the injector at a smooth, consistent speed. Frame 220 can include arms/connectors 225, 227 that extend to connect frame 220 to the tractor. Flap 223 is disposed at the bottom of chute 230 to control the size of the opening 235 which the compost or soil amendment flows through. The position and/or orientation of flap 223 can be adjusted to increase or decrease the size of opening 235. Adjusting the size of opening 235 can control the flow rate of compost or soil amendment through the apparatus 200.

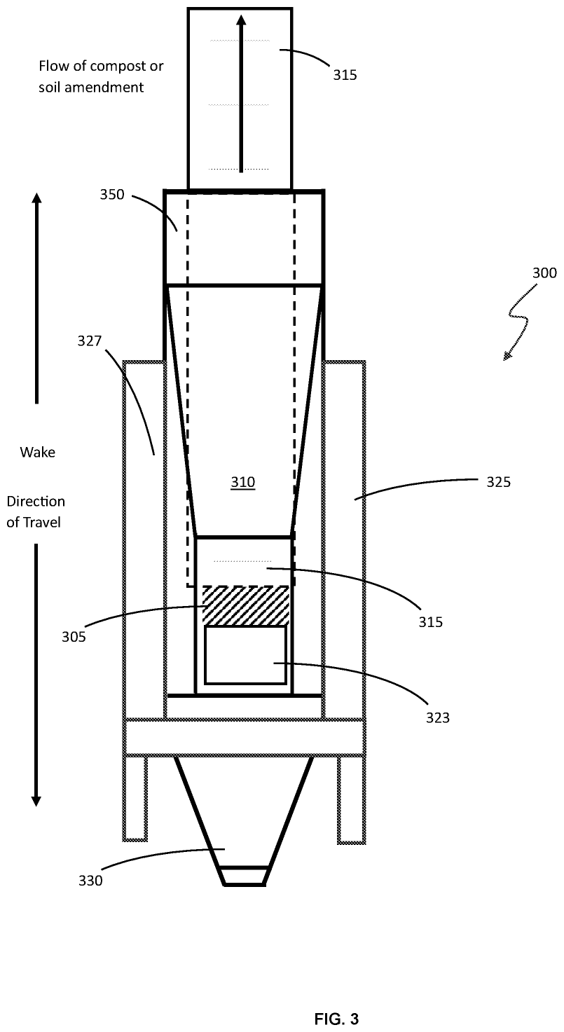

FIG. 3 depicts an exemplary apparatus 300 including an injector 350 for performing deep soil amendment using a conveyor 315 to move compost, biochar, and other soil amendments provided to chute 310 of injector 350 according to embodiments of the present invention. As the leading bow (e.g., shank and blades) 330 is dragged forward through the soil, a void 305 is created in the soil and supported by the lateral walls 325, 327 of injector 350. Conveyor 315 is disposed below chute 310 in a position that allows the amendment (e.g., compost) to reach different parts of chute 310. For example, some of the amendment falls directly down into the void 305 towards the front of injector 350, and some of the amendment falls onto the rear conveyor 315. The amendment can be transported by a separate vehicle that tracks the path of the tractor (e.g., runs alongside the tractor). Advantageously, using conveyor 315 in this way helps prevent compost from blocking the opening of injector 350 while the injector 350 moves forward through the soil. The amount of amendment that falls onto conveyor 315 compared to the amount that falls directly into opening 305 can be adjusted based on the position, angle or incline of the conveyor 315, and can be further adjusted based on the rate that the amendment is loaded into chute 310. Moreover, flap 323 can be opened/closed to increase or decrease the size of opening 305. The amendment can be supplied to the conveyor from a trailer or other equipment (e.g., storage tank) hauled by the heavy equipment (e.g., tractor) that pulls injector 350, or the trailer can be hauled separately by another tractor or truck (e.g., a dump truck), for example.

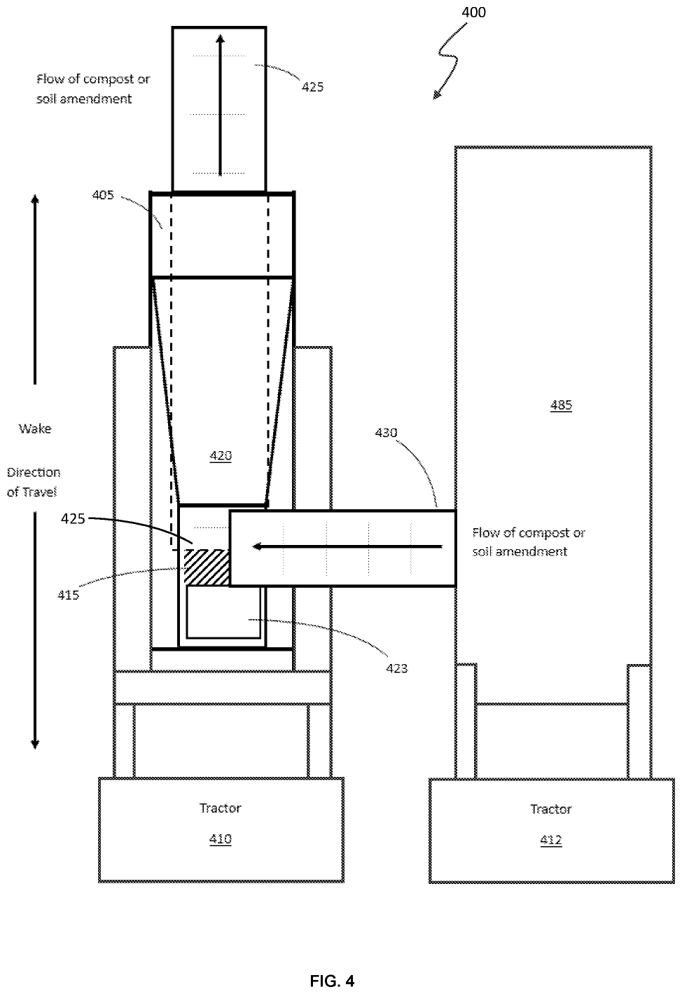

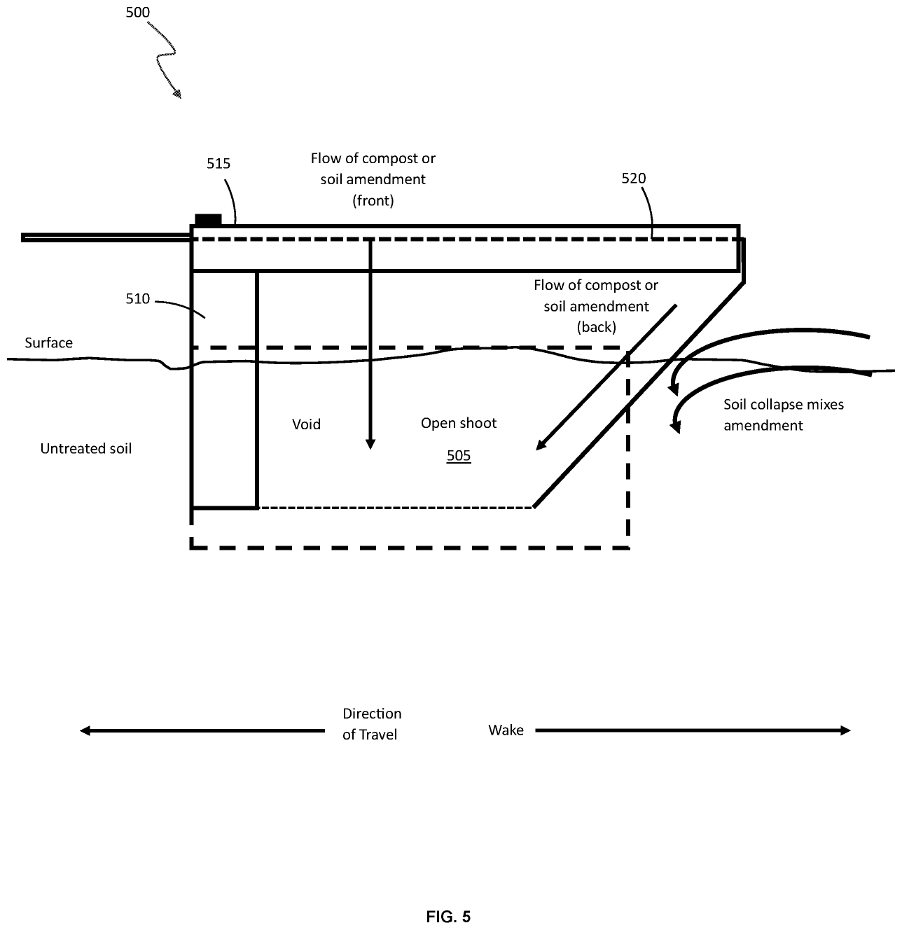

FIG. 4 depicts an exemplary apparatus 400 for performing deep soil amendment using an injector connected to a tractor 410 and fed using a conveyor that receives compost, biochar, and other amendments from another conveyor connected to or fed by a second piece of equipment (e.g., a dump truck) 485 moving in parallel to the tractor according to embodiments of the present invention. As the leading bow (e.g., shank and blades) is dragged forward through the soil, a void 415 is created in the soil, and amendment is fed into chute 420 by conveyor 430 that transports amendment from truck, tractor, or supply tank 485. Some of the amendment provided by conveyor 430 falls directly into opening 415, while the rest of the amendment falls onto conveyor 425 that provides the amendment into a collapsing void in the soil behind the apparatus 400. The position of conveyors 425, 430 can be adjusted so that different amounts of amendment fall into the soil directly, and to bias the front or rear distribution of the amendment. For example, the position, angle, and incline of the conveyors 425, 430, can be adjusted to distribute the falling amendment differently (e.g., onto conveyor 425 or directly into void 415). Moreover, the amount/rate that the amendment loaded onto the conveyors 425, 430 can be adjusted which can affect how the amendment is distributed. According to some embodiments, 70% of the amendment falls onto conveyor 425, and 30% of the amendment falls directly into opening 415. Moreover, flap 423 can be opened/closed to increase or decrease the size of opening 415. As described in more detail below with regard to FIG. 5, 6, the wake and turbulence created behind injector 405 completely mix the amendment into the soil at depths of up to 3 feet when the void in the soil collapses as tractor 410 pulls injector 405 forward.

FIG. 5 depicts an exemplary apparatus 500 for performing deep soil amendment using an injector 520 from a side view above and below the soil line according to embodiments of the present invention. In the example of FIG. 5, injector 520 includes a bow-shaped shank and blades 510 connected to a heavy-duty steel frame 515 that connects injector 520 to a truck or tractor that pulls injector 520 through the soil to ameliorate the soil in a vineyard or orchard, for example. Amendment is fed into the open chute 505 of the injector 520 and falls into the void as the injector 520 moves forward through the soil; the amendment is mixed thoroughly with the soil as the soil collapses in the wake of injector 520. Injector 520 is partially above the surface of the soil and partially below the surface of the soil during operation. According to some embodiments, open chute 550 is 4 feet tall and extends roughly 3 feet below the surface of the soil. Deeper application of amendment typically requires a more powerful tractor to pull the injector 520 through deeper soil.

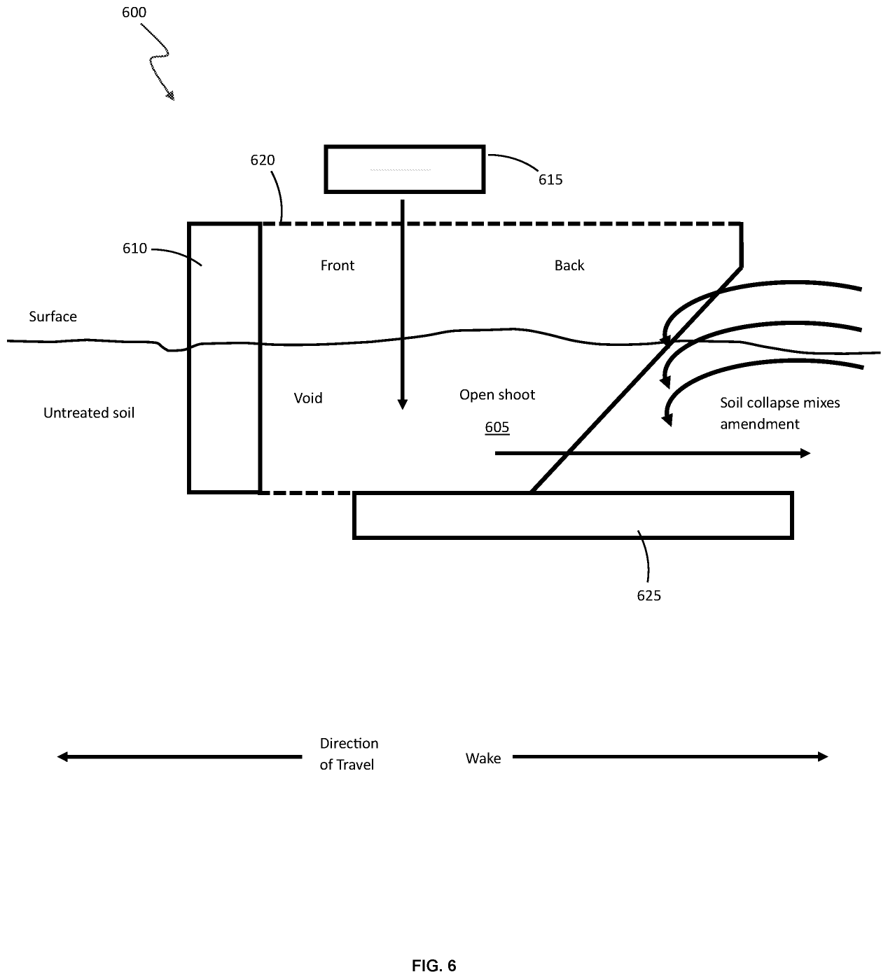

FIG. 6 depicts an exemplary apparatus 600 for performing deep soil amendment using an adjustable conveyor 615 from a side view above and below the soil line according to embodiments of the present invention. In the example of FIG. 6, conveyor 615 can be moved closer to the front or the back of the open chute 605 to change the distribution of amendment to accommodate different types of amendments, different soil conditions, etc. For example, the delivery angle of the amendment can bring more of the amendment straight down into the void formed in open chute 605, or more amendment can be dropped over the rear conveyor 625 toward the back of open chute 610 to prevent clogs in the chute, for example. Rear conveyor 625 transports the soil amendment behind apparatus 600 allowing it to mix into the wake of the soil. According to some embodiments, a 40% front, 60% back distribution is achieved using adjustable conveyor 625 to mix amendment with the soil at depths of up to 3 feet. As the injector 620 moves forward through the soil, and the amendment is mixed thoroughly with the soil as the soil collapses in the wake of injector 620. The injector 620 is partially above the surface of the soil and partially below the surface of the soil during operation. According to some embodiments, open chute 605 is 4 feet tall and extends roughly 3 feet below the surface of the soil. The embodiment depicted in FIG. 6 can be connected to a frame and pulled by a tractor (e.g., steel frame 515).

FIG. 7 is a flow chart depicting exemplary steps of a process 700 for performing deep soil amendment to condition soil with compost or other soil amendments using conveyors to move the amendments from a truck (or tractor, etc.) moving parallel to an injector according to embodiments of the present invention. The injector is typically pulled by a heavy-duty tractor through the ground roughly 3 feet below the surface of the soil.

At step 705, compost or other soil amendments are transferred from the truck moving parallel to the injector using a first conveyor.

At step 710, the compost or amendment transferred in step 705 is received from the first conveyor at a second conveyor that transports the amendment into the injector. Some of the compost provided to the injector falls directly into a void in the soil. The second conveyor is typically attached to the injector and/or to the frame used to pull the injector.

At step 715, the injector is dragged forward through the soil by the tractor to create a void in the soil typically extending 1-3 feet below the surface of the soil.

At step 720, amendment is transferred into the void created by the injector as it is pulled forward through the soil by the tractor. Some of the amendment lands on a third conveyor disposed below the injector that moves the amendment into the soil behind the injector, allowing it to mix thoroughly in the wake. The soil collapses into the void and mixes the amendment with the soil as the tractor moves forward. The soil and amendment can be completely mixed at depths of up to 3 feet according to embodiments.

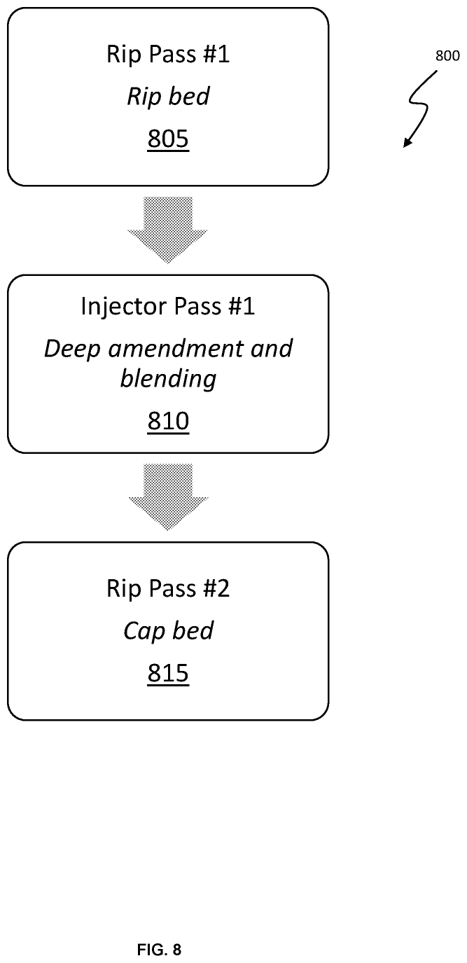

FIG. 8 is a flow chart depicting exemplary steps of a process 800 for conditioning soil including deep soil amendment that is mixed with the soil by an injector according to embodiments of the present invention. Steps 805-815 are typically performed using special equipment, such as a ripper and injector in conjunction with a tractor, truck, or the like that can pull the equipment through a vineyard, field, or orchard at a roughly consistent speed during operation. Process 800 is typically performed prior to planting in the soil bed and produces a highly ameliorated soil bed that can significantly improve plant health and yields in a vineyard or orchard, for example.

At step 805, a first pass is performed with a ripper (e.g., a precision ripper) to break up and loosen compacted soil in a soil bed. The soil bed can be ripped at a depth of roughly 4 feet, according to some embodiments.

At step 810, a pass is performed with an injector to amend and mix the soil bed with compost or other soil amendments at depths of roughly 3 feet, although deeper amendment can be performed which may involve additional mixing using a ripper, for example. The amendment can include compost, biochar, etc.

At step 815, a second ripper pass is optionally performed to cap the soil bed, and a final mixing of the soil and the amendment can be performed by the ripper at depths of 3-4 feet, according to some embodiments. Capping the bed can prevent the soil from collapsing down further (forming a ditch) and helps keep the surface roughly level. Step 815 can be performed using a precision ripper, mounder, bedder, shank, double blade, etc., or any combination thereof.

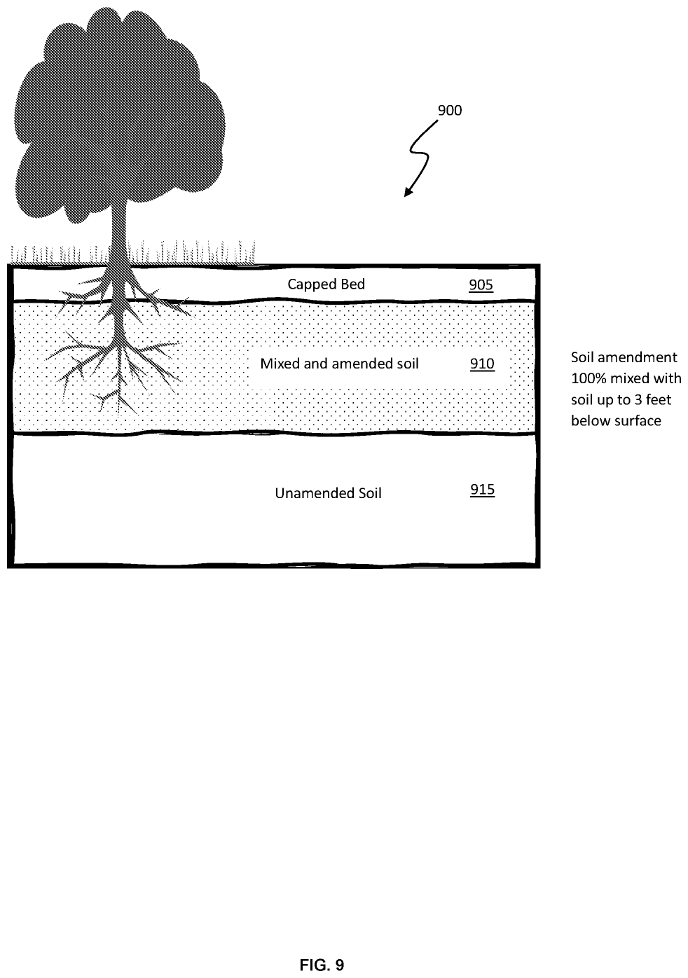

FIG. 9 depicts an exemplary ameliorated soil bed 900 amended using an injector according to embodiments of the present invention. In the example of FIG. 9, soil bed 900 includes unamended soil 915 at depths greater than 3 or 4 feet. Above the unamended soil 915, mixed and amended soil 910 includes compost and/or other soil amendments that have been injected and mixed into the soil bed 900 using an injector pulled by a tractor, for example. The mixed and amended (ameliorated) soil 910 is 100% blended at depths of 3 feet to provide nutrients and optimal soil conditions for the root zones of established trees, plants, or vines (e.g., 3-4 feet). Above the ameliorated soil 910, a capped bed 905 helps maintain soil structure and advantageously keeps the surface of the soil from collapsing down (forming a ditch). In this way, the health and productivity of trees, plants, or vines in soil bed 900 is improved significantly by the deep soil amendment performed by the injector.

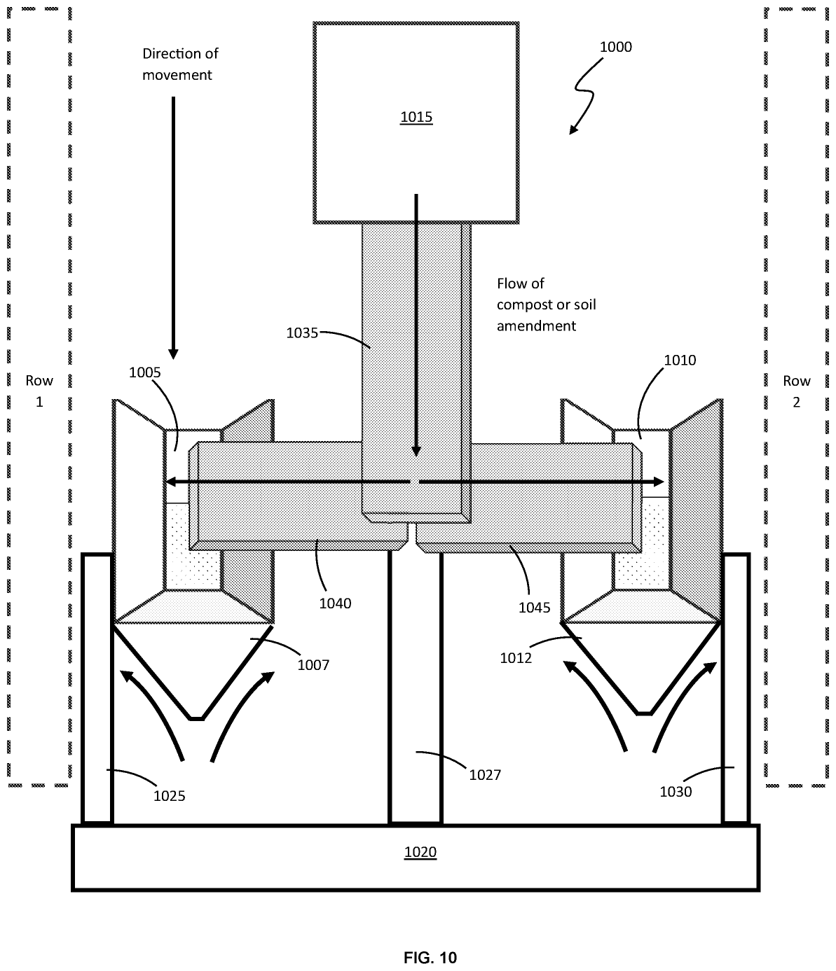

FIG. 10 depicts an exemplary apparatus 1000 (“double injector”) for performing deep soil amendment using two injectors 1005, 1010 traveling parallel to rows of a vineyard or the like according to embodiments of the present invention. Apparatus 1000 is particularly well-suited for use between rows of a vineyard to treat soil near already established vines. Injectors 1005, 1010 can be much smaller than the injectors depicted above in FIGS. 1-4. For example, the shanks of injectors 1005, 1010 can be roughly 1.5 inches wide and can reach roughly 30 inches below the surface of the soil. In the example of FIG. 10, injectors 1005, 1010 receive compost from conveyors 1040, 1045 (“injector conveyors”), respectively, which are fed by a common conveyor 1015 that receives amendment carried by amendment storage 1015 (e.g., a truck, trailer, or storage tank). The amendment travels down conveyor 1015, which can be positioned at an upward incline, and falls down onto injector conveyors 1040, 1045.

The injector conveyors 1040, 1045 feed roughly half of the amendment to injector 1005, and feed the other half to injector 1010. Injectors 1005, 1010 are pulled forward through the soil by tractor 1020 that is connected to injectors 1005, 1010 by a heavy-duty steel frame 1027. Steel frame 1027 can include lateral arms 1025, 1030 that connect to injectors 1005, 1010, and the steel frame 1027 can also support conveyors 1035, 1040, 1045, as well as amendment storage 1015. The leading shanks and blades 1007, 1012 of injectors 1005, 1010 cut through the soil as tractor 1020 pulls apparatus 1000 forward. As amendment falls into the voids created by injectors 1005, 1010, the void collapses behind the injectors 1005, 1010 and mixes the amendment into the soil.

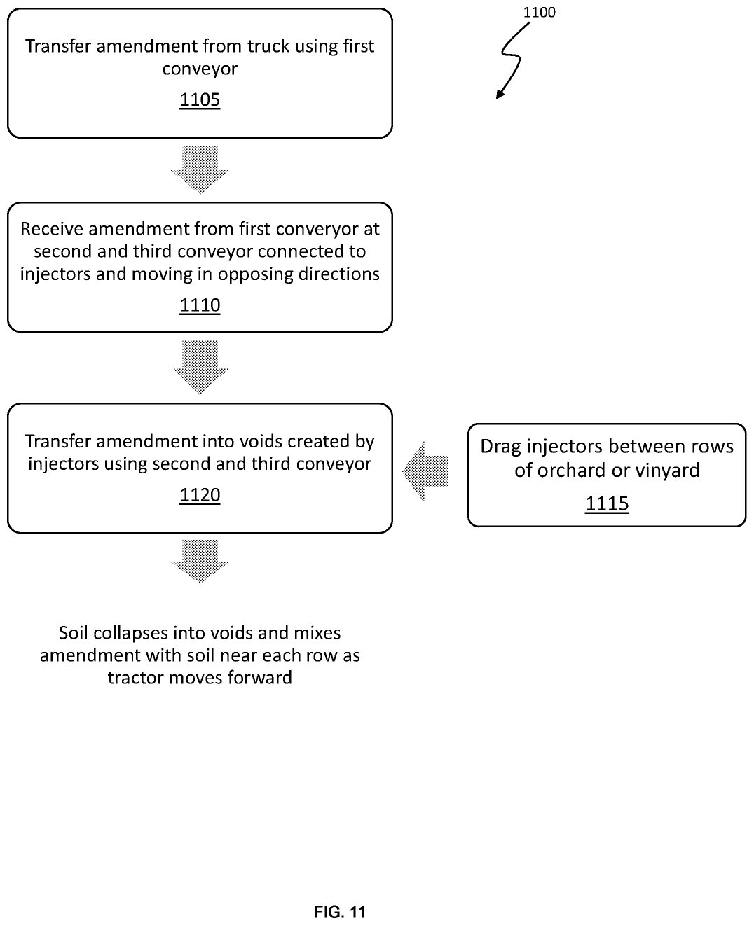

FIG. 11 is a flow chart depicting exemplary steps of a process 1100 for performing deep soil amendment using two injectors traveling between and parallel to rows of a vineyard, orchard, or the like according to embodiments of the present invention. The injectors are typically pulled by a tractor and fed amendment by conveyors that receive the amendment from another conveyor connected to a trailer or amendment storage tank, for example. The trailer can be connected to a steel frame that supports the conveyors and/or the injectors, and the tractor pulls the frame forward during operation.

At step 1105, compost or other soil amendments are transferred from the trailer using a first conveyor.

At step 1110, amendment is received from the first conveyor at second and third conveyors that feed the injectors. The second and third conveyors are typically attached to a heavy-duty steel frame connected to the injectors.

At step 1115, the injectors are dragged forward through the soil by the tractor to create voids in the soil typically extending about 30 inches below the surface of the soil.

At step 1120, amendment is transferred into the voids created by the injectors being pulled forward through the soil by the tractor. The soil collapses into void and advantageously mixes the amendment with the soil as the tractor moves forward. The soil and amendment can be completely mixed at depths of up to 30 inches using a double injector according to embodiments.

Embodiments of the present invention are thus described. While the present invention has been described in particular embodiments, it should be appreciated that the present invention should not be construed as limited by such embodiments, but rather construed according to the following claims.

What is claimed is:

1. An apparatus for conditioning soil by performing deep soil amendment, the apparatus comprising:
a shank operable to be dragged forward through the soil by a tractor;
lateral blades coupled to the shank; and
lateral walls coupled to the lateral blades forming an open chute that extends a depth down below a surface of the soil, wherein the open chute is operable to receive amendment and to create a wake in the soil when pulled forward through the soil by the tractor, and wherein the wake substantially mixes the amendment with the soil down to the depth.

2. The apparatus of claim 1, further comprising a steel frame operable to connect the shank to the tractor.

3. The apparatus of claim 1, wherein the shank comprises a 3-inch-wide steel shank.

4. The apparatus of claim 1, wherein the lateral blades comprise steel blades.

5. The apparatus of claim 1, further comprising chromium carbide wear plates disposed on outer surfaces of the steel blades.

6. The apparatus of claim 1, wherein the lateral walls are substantially 4 feet high and operable to reach 3 feet under a surface of the soil during operation.

7. The apparatus of claim 1, wherein the depth is approximately 3 feet and wherein the amendment reaches substantially 3 feet below a surface of the soil and is substantially mixed with the soil by the wake.

8. The apparatus of claim 1, further comprising a first conveyor operable to receive the amendment after passing through the open the open chute and to move the amendment into soil behind the open chute.

9. The apparatus of claim 8, wherein the first conveyor receives the amendment from a trailer connected to the tractor.

10. The apparatus of claim 8, wherein the first conveyor receives the amendment from a truck moving parallel to the tractor.

11. The apparatus of claim 8, further comprising a second conveyor that provides the amendment to the first conveyor, wherein the second conveyor receives the amendment from a truck moving parallel to the tractor.

12. The apparatus of claim 8, wherein a position of the first conveyor beneath the open chute is adjustable, and wherein the open chute comprises a rear sloped surface that guides the amendment into the void.

13. The apparatus of claim 1, wherein the amendment comprises compost.

14. An apparatus for performing deep soil amendment, the apparatus comprising:
a leading bow-shaped edge;
a rigid hollow structure coupled to the edge and operable to be moved forward through soil to create a moving void in the soil;
a frame disposed on top of the structure and removably coupled to the structure; and
a tractor coupled to the frame and operable to pull the edge and the structure forward through the soil to create the moving void, wherein amendment is dropped into an opening of the structure and into the moving void, and wherein a wake produced by the structure moving forward through the soil substantially mixes the amendment with the soil behind the structure.

15. The apparatus of claim 14, wherein the edge comprises a 3-inch-wide steel shank and steel lateral blades.

16. The apparatus of claim 15, further comprising chromium carbide wear plates disposed on outer surfaces of the steel lateral blades.

17. The apparatus of claim 14, wherein the structure is substantially 4 feet high and operable to reach 3 feet under a surface of the soil during operation.

18. The apparatus of claim 14, wherein the amendment reaches substantially 3 feet below a surface of the soil and is substantially mixed with the soil by the wake.

19. An apparatus for performing deep soil amendment for two parallel rows, the apparatus comprising:
a frame coupled to a tractor and to first and second injectors, wherein the first and second injectors comprise open chutes and are operable to create moving voids in the soil when pulled through the soil by the tractor;
an amendment storage;
a first conveyor that transports amendment from the amendment storage to a second conveyor and a third conveyor, wherein the second conveyor and a third conveyor transport the amendment in substantially opposite directions; and
the second conveyor and the third conveyor operable to provide the amendment to the first and second injectors, respectively, wherein the amendment falls through the open chutes of the injectors and into the moving voids, and wherein the first and second injectors create a wake behind the injectors that substantially mixes the amendment with the soil as the moving voids collapse.

20. The apparatus of claim 19, wherein the amendment storage comprises a trailer connected to the frame and pulled by the tractor.
